(19) United States
(12) Patent Application Publication
(10) Pub. No.: US 2026/0143039 A1
(43) Pub. Date: May 21, 2026

(54) PLATFORM FOR PROCESSING AND RENDERING LARGE SCALE DATA FROM DISPARATE SOURCES

(71) Applicant: OneHAP, Inc., Seattle, WA (US)

(72) Inventors: Mikel Samaniego, Seattle, WA (US); Karina Helena Yamin Perez, Kirkland, WA (US)

(21) Appl. No.: 19/377,875

(22) Filed: Nov. 3, 2025

Related U.S. Application Data
(60) Provisional application No. 63/715,941, filed on Nov. 4, 2024.

(51) Int. Cl. H04L 67/52; H04L 67/306

(52) U.S. Cl. CPC H04L 67/52; H04L 67/306

(57) ABSTRACT

Systems, methods, and computer program products for processing and rendering large-scale data from disparate sources are provided. An example method includes receiving a user profile associated with a user. The user profile includes a user type and a geolocation relating to the user. The method also includes determining one or more potential providers from one or more providers for the user based on the user profile. The one or more potential providers is determined based on a known provider location for each of the one or more providers. The method further includes causing a rendering of the one or more potential providers for selection to be associated with the user. The rendering of the one or more potential providers includes a distance between the known provider location for each of the one or more potential providers and the geolocation relating to the user.

### CROSS-REFERENCE TO RELATED APPLICATIONS

The present application claims priority to U.S. Patent Application No. 63/715,941 entitled “PLATFORM FOR PROCESSING AND RENDERING LARGE SCALE DATA FROM DISPARATE SOURCES” filed on Nov. 4, 2024; the entirety of the application is incorporated herein by reference.

### FIELD

An example embodiment relates generally to platform(s) for processing and rendering data, and more particularly, to platform(s) for processing and rendering large-scale data from disparate sources including geolocation data.

### BACKGROUND

Data gathered for users can be difficult to process effectively as the amount of different data sources increase. As the amount of data is increased, the ability for a user to process and effectively display the data for practical use is almost impossible. As such, currently there is a limitation to the size and scale of data allowed for effectively user interaction and processing. Therefore, there exists a need for a system that can process and render large-scale data from disparate sources infrastructure.

### SUMMARY

The following paragraphs present a summary of various embodiments of the present disclosure and are merely examples of potential embodiments. As such, the summary is not meant to limit the subject matter or variations of various embodiments discussed herein.

In some aspects, the techniques described herein relate to a method for processing and rendering large-scale data from disparate sources, the method including: receiving a user profile associated with a user, wherein the user profile includes a user type and a geolocation relating to the user; determining one or more potential providers from one or more providers for the user based on the user profile, wherein the one or more potential providers is determined based on a known provider location for each of the one or more providers; and causing a rendering of the one or more potential providers for selection to be associated with the user, wherein the rendering of the one or more potential providers includes a distance between the known provider location for each of the one or more potential providers and the geolocation relating to the user.

In some aspects, the techniques described herein relate to a method, further including determining a primary provider of the one or more potential providers.

In some aspects, the techniques described herein relate to a method, wherein determining the primary provider is based on the distance between the known provider location of each of the one or more potential providers and the geolocation associated with the user.

In some aspects, the techniques described herein relate to a method, further including assigning the primary provider to the user profile, wherein the primary provider is linked to the user profile.

In some aspects, the techniques described herein relate to a method, wherein the primary provider is assigned one or more tasks associated with the user.

In some aspects, the techniques described herein relate to a method, wherein the one or more tasks are rendered via a user interface on a device associated with the primary provider.

In some aspects, the techniques described herein relate to a method, wherein the one or more potential providers are filtered based on an availability for each of the one or more potential providers.

In some aspects, the techniques described herein relate to a method, wherein the availability of each of the one or more potential providers is determined based on a calendar for each of the one or more potential providers.

In some aspects, the techniques described herein relate to a method, wherein filtering the one or more potential providers includes removing any potential provider that is unavailable for a potential contact with the user.

In some aspects, the techniques described herein relate to a method, further including removing one or more potential providers based on the user type of the user profile, wherein the removal is based on a provider profile associated with each of the one or more potential providers.

In some aspects, the techniques described herein relate to a method, wherein the user type includes information relating to services to be provided to the user.

In some aspects, the techniques described herein relate to a method, further including providing route information between the known provider location of at least one of the one or more potential providers and the geolocation of the user.

In some aspects, the techniques described herein relate to a method, further including receiving an input selecting a primary provider of the one or more potential providers.

In some aspects, the techniques described herein relate to a method, wherein the known provider location is fixed for each of the one or more providers.

In some aspects, the techniques described herein relate to a method, wherein the geolocation relating to the user is based on an expected location of the user at a given time.

In some aspects, the techniques described herein relate to a system for processing and rendering large-scale data from disparate sources, the system including: at least one non-transitory storage device; and at least one processing device coupled to the at least one non-transitory storage device, wherein the at least one processing device is configured to: receive a user profile associated with a user, wherein the user profile includes a user type and a geolocation relating to the user; determine one or more potential providers from one or more providers for the user based on the user profile, wherein the one or more potential providers is determined based on a known provider location for each of the one or more providers; and cause a rendering of the one or more potential providers for selection to be associated with the user, wherein the rendering of the one or more potential providers includes a distance between the known provider location for each of the one or more potential providers and the geolocation relating to the user.

In some aspects, the techniques described herein relate to a system, wherein the at least one processing device is further configured to determine a primary provider of the one or more potential providers.

In some aspects, the techniques described herein relate to a system, wherein determining the primary provider is based on the distance between the known provider location of each of the one or more potential providers and the geolocation associated with the user.

In some aspects, the techniques described herein relate to a system, wherein the at least one processing device is further configured to assign the primary provider to the user profile, wherein the primary provider is linked to the user profile.

In some aspects, the techniques described herein relate to a system, wherein the primary provider is assigned one or more tasks associated with the user.

In some aspects, the techniques described herein relate to a system, wherein the one or more tasks are rendered via a user interface on a device associated with the primary provider.

In some aspects, the techniques described herein relate to a system, wherein the one or more potential providers are filtered based on an availability for each of the one or more potential providers.

In some aspects, the techniques described herein relate to a system, wherein the availability of each of the one or more potential providers is determined based on a calendar for each of the one or more potential providers.

In some aspects, the techniques described herein relate to a system, wherein filtering the one or more potential providers includes removing any potential provider that is unavailable for a potential contact with the user.

In some aspects, the techniques described herein relate to a system, wherein the at least one processing device is further configured to remove one or more potential providers based on the user type of the user profile, wherein the removal is based on a provider profile associated with each of the one or more potential providers.

In some aspects, the techniques described herein relate to a system, wherein the user type includes information relating to services to be provided to the user.

In some aspects, the techniques described herein relate to a system, wherein the at least one processing device is further configured to provide route information between the known provider location of at least one of the one or more potential providers and the geolocation of the user.

In some aspects, the techniques described herein relate to a system, wherein the at least one processing device is further configured to receive an input selecting a primary provider of the one or more potential providers.

In some aspects, the techniques described herein relate to a system, wherein the known provider location is fixed for each of the one or more providers.

In some aspects, the techniques described herein relate to a system, wherein the geolocation relating to the user is based on an expected location of the user at a given time.

In some aspects, the techniques described herein relate to a computer program product for processing and rendering large-scale data from disparate sources, the computer program product including at least one non-transitory computer-readable medium having one or more computer-readable program code portions embodied therein, the one or more computer-readable program code portions including at least one executable portion configured to: receive a user profile associated with a user, wherein the user profile includes a user type and a geolocation relating to the user; determine one or more potential providers from one or more providers for the user based on the user profile, wherein the one or more potential providers is determined based on a known provider location for each of the one or more providers; and cause a rendering of the one or more potential providers for selection to be associated with the user, wherein the rendering of the one or more potential providers includes a distance between the known provider location for each of the one or more potential providers and the geolocation relating to the user.

In some aspects, the techniques described herein relate to a computer program product, wherein the one or more computer-readable program code portions include at least one executable portion further configured to determine a primary provider of the one or more potential providers.

In some aspects, the techniques described herein relate to a computer program product, wherein determining the primary provider is based on the distance between the known provider location of each of the one or more potential providers and the geolocation associated with the user.

In some aspects, the techniques described herein relate to a computer program product, wherein the one or more computer-readable program code portions include at least one executable portion further configured to assign the primary provider to the user profile, wherein the primary provider is linked to the user profile.

In some aspects, the techniques described herein relate to a computer program product, wherein the primary provider is assigned one or more tasks associated with the user.

In some aspects, the techniques described herein relate to a computer program product, wherein the one or more tasks are rendered via a user interface on a device associated with the primary provider.

In some aspects, the techniques described herein relate to a computer program product, wherein the one or more potential providers are filtered based on an availability for each of the one or more potential providers.

In some aspects, the techniques described herein relate to a computer program product, wherein the availability of each of the one or more potential providers is determined based on a calendar for each of the one or more potential providers.

In some aspects, the techniques described herein relate to a computer program product, wherein filtering the one or more potential providers includes removing any potential provider that is unavailable for a potential contact with the user.

In some aspects, the techniques described herein relate to a computer program product, wherein the one or more computer-readable program code portions include at least one executable portion further configured to remove one or more potential providers based on the user type of the user profile, wherein the removal is based on a provider profile associated with each of the one or more potential providers.

In some aspects, the techniques described herein relate to a computer program product, wherein the user type includes information relating to services to be provided to the user.

In some aspects, the techniques described herein relate to a computer program product, wherein the one or more computer-readable program code portions include at least one executable portion further configured to provide route information between the known provider location of at least one of the one or more potential providers and the geolocation of the user.

In some aspects, the techniques described herein relate to a computer program product, wherein the one or more computer-readable program code portions include at least one executable portion further configured to receive an input selecting a primary provider of the one or more potential providers.

In some aspects, the techniques described herein relate to a computer program product, wherein the known provider location is fixed for each of the one or more providers.

In some aspects, the techniques described herein relate to a computer program product, wherein the geolocation relating to the user is based on an expected location of the user at a given time.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 provides a block diagram illustrating a system environment for processing and rendering large-scale data from disparate sources, in accordance with various embodiments of the present disclosure;

FIG. 2 provides a block diagram illustrating the entity server(s) 151 of FIG. 1, in accordance with various embodiments of the present disclosure;

FIG. 3 provides a block diagram illustrating the computing device(s) 152 of FIG. 1, in accordance with various embodiments of the present disclosure;

FIG. 4 is a flow chart that details a method of processing and rendering large-scale data from disparate sources, in accordance with various embodiments of the present disclosure;

FIGS. 5A and 5B illustrate an admin dashboard rendered via a user interface, in accordance with various embodiments of the present disclosure;

FIGS. 6A and 6B illustrate the admin dashboard that includes information relating to outreach advocates, in accordance with various embodiments of the present disclosure;

FIGS. 7A and 7B illustrate a provider dashboard rendered via a user interface, in accordance with various embodiments of the present disclosure;

FIG. 8 illustrates a member list page rendered via a user interface, in accordance with various embodiments of the present disclosure;

FIG. 9 illustrates a client import page 900 in accordance with various embodiments.

FIGS. 10A and 10B illustrate a user profile page 1000 rendered via a user interface, in accordance with various embodiments of the present disclosure;

FIGS. 11A and 11B illustrate a user interface 1100 that is rendered for recording interactions with a user, in accordance with various embodiments of the present disclosure;

FIG. 12 illustrates another example user profile page 1200 rendered via a user interface, in accordance with various embodiments of the present disclosure;

FIGS. 13A and 13B illustrates an example billing page 1300 rendered via a user interface, in accordance with various embodiments of the present disclosure; and

FIGS. 14A and 14B illustrates an example contact page 1400 rendered via a user interface, in accordance with various embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Example Use Case

Data gathered for users can be difficult to process effectively as the amount of different data sources increase. As the amount of data is increased, the ability for a user to process and effectively display the data for practical use is almost impossible. As such, currently there is a limitation to the size and scale of data allowed for effectively user interaction and processing. This is especially difficult for organizations that are managing large scale in-person connections. Occupations that require in-person contact, such as physical therapists, occupational therapists, doctors, may be required to provide non-office meetings (e.g., at-home visits for a patient unable to visit a traditional office). However, long distances between patients and providers create unnecessary burdens on a provider. Therefore, traditional systems often use a dispatcher that manually assigns providers to patients or the patient is required to contact providers directly to determine whether the provider would be willing and/or able to travel to the patient. However, manual dispatching is limited in scale, due to the ability of a person to handle more people. As such, dispatchers are unable to effectively assist in a timely and effective manner.

Various embodiments of the present disclosure provide processing and rendering large-scale data from disparate sources including geolocation data. To do this, the present disclosure provides for platform(s) that allow providers to be connected to users (e.g., patients) and coordinated throughout the process of service. A user may be assigned as a primary provider and provided with task(s) to be completed associated with the service of the user. The platform may allow for the assignment of providers, the coordination of task(s) for given users and providers, the documentation of interactions between providers and users, and/or the like. The term system, platform, and portal may be used interchangeably to refer to the various system(s) of the present disclosure.

In some aspects, the techniques described herein relate to a method for processing and rendering large-scale data from disparate sources, the method including: receiving a user profile associated with a user, wherein the user profile includes a user type and a geolocation relating to the user; determining one or more potential providers from one or more providers for the user based on the user profile, wherein the one or more potential providers is determined based on a known provider location for each of the one or more providers; and causing a rendering of the one or more potential providers for selection to be associated with the user, wherein the rendering of the one or more potential providers includes a distance between the known provider location for each of the one or more potential providers and the geolocation relating to the user.

In various embodiments, systems and/or computer program products may be provided configured to carry out the operations of the method discussed herein.

While the term patient is used herein along with the term “user”, the operations discussed herein may extend beyond provider/patient applications and extend to any user and provider that may be considered.

### II. With Reference to the FIGs.

Reference will now be made in detail to aspects of the disclosure, examples of which are illustrated in the accompanying drawings. The following description refers to the accompanying drawings in which the same numbers in different drawings represent the same or similar elements unless otherwise represented. The implementations set forth in the following description do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

Systems, methods, and apparatuses are described herein which relate generally to processing and rendering large-scale data from disparate sources. In the following description, for purposes of explanation, numerous specific details are set forth to provide a thorough understanding of the present disclosure. It will be evident, however, to one skilled in the art that the present disclosure may be practiced without these specific details and/or with any combination of these details.

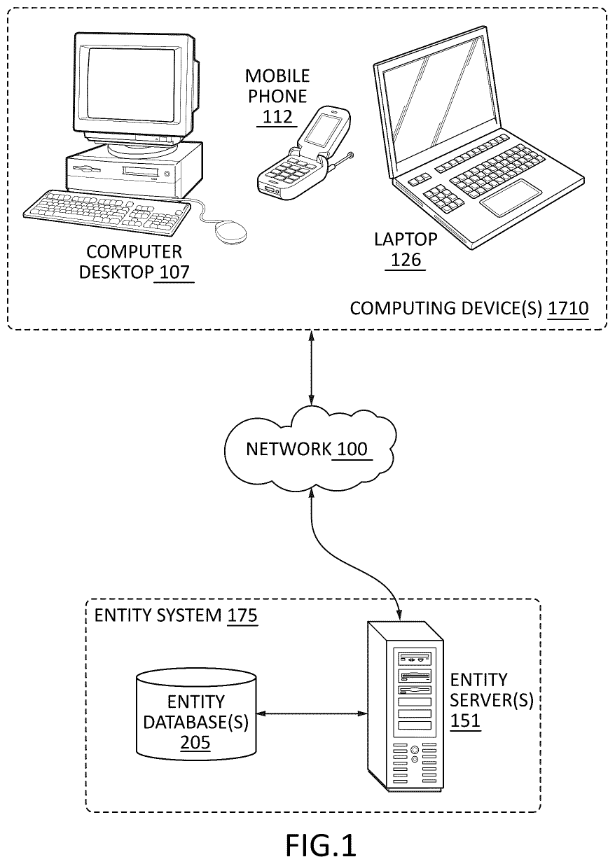

Referring now to FIG. 1, a block diagram illustrating a system environment (“system”) for processing and rendering large-scale data from disparate sources, in accordance with various embodiments is provided. The system includes computing device(s) 152 and an entity system 175 connected to a network 100. As shown, the computing device(s) 152 (e.g., desktop computer 107, mobile phone 112, laptop 126, and/or the like) associated with accounts are in communication with network 100. Computing device(s) 152 may be associated with users (e.g., patients or customers), entity users (e.g., entity employees or administrators), providers (e.g., care coordinators), outreach advocates, and/or other account holders that are part of the system.

The entity system 175 is also in communication with the network 100. The entity system 175 includes one or more entity servers 151 and one or more entity databases 205. In various embodiments, the entity server(s) 151 may be made of multiple servers. In various embodiments, the entity database(s) 205 may be part of the entity server(s) 151 (e.g., at least a portion of the entity database(s) 205 may be stored on the memory device(s) 268 of the entity server(s) 151). Additionally or alternatively, at least a portion of the entity database(s) 205 may be stored remote from the entity server(s) 151. The entity database(s) 205 may be part or, or in communication with the entity system 175. The entity database(s) 205 may include entity data for one or more entities. The entity database(s) 205 may include the entity data across multiple entities (e.g., a vendor may store and/or provide entity data for multiple entities). The format of the entity data stored on the entity database(s) 205 may be based on the front-end interface of the entity server(s) 151.

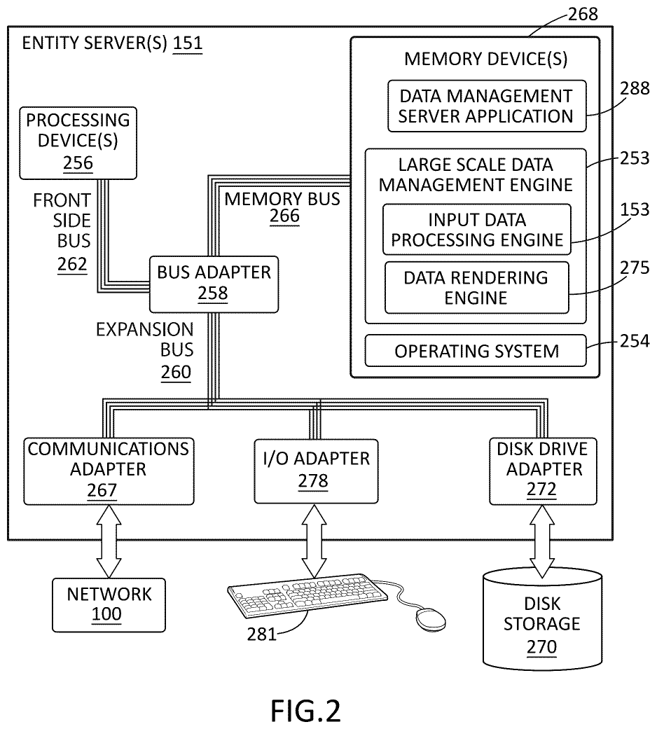

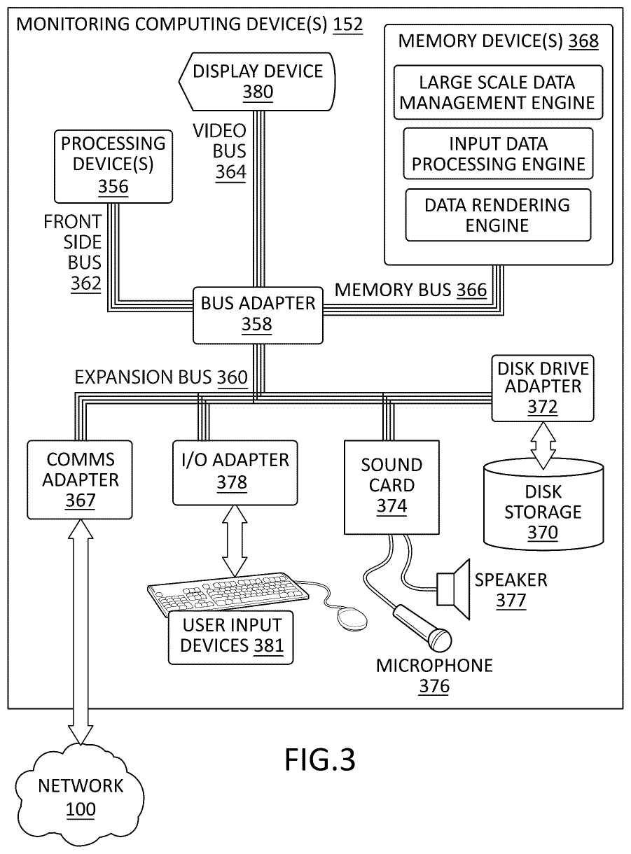

Referring now to FIG. 2, a block diagram illustrating the entity server(s) 151 of FIG. 1 in accordance with various embodiments is provided. FIG. 2 is merely illustrative of an example entity server(s) 151. In various embodiments, the entity server(s) 151 may share components with the computing device(s) 152 (e.g., the entity server(s) 151 may use at least a portion of the processing device(s) 356 of the computing device(s) 152 shown in FIG. 3). The entity server(s) 151 may be comprised of one or more servers. In various embodiments, the entity server(s) 151 may be capable of processing user inputs via a computing device(s) 152 and generating user interfaces to be rendered to computing device(s) 152.

The entity server(s) 151 of FIG. 2 includes one or more processing devices 256 and one or more memory devices 268, communication adapter 267, an input/output adapter 278, and a disk drive adapter 272. In various embodiments, the various components may be connected to one another via a BUS adapter 258 (e.g., the processing device(s) 256 may be attached via a front side BUS 262, the memory device(s) 268 may be attached via a memory BUS 266, and the communication adapter 267, I/O adapter 278, disk drive adapter 272, and/or other interfaces may be attached via expansion BUS 260).

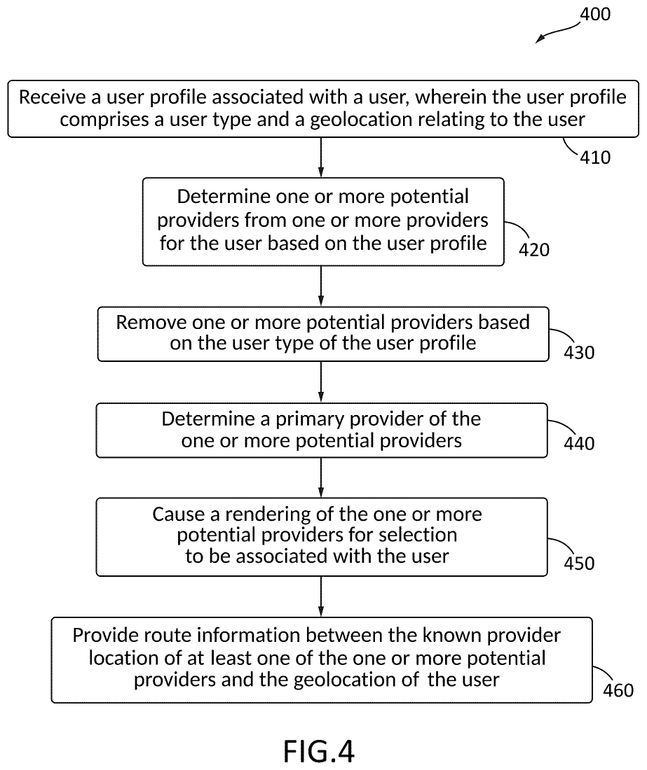

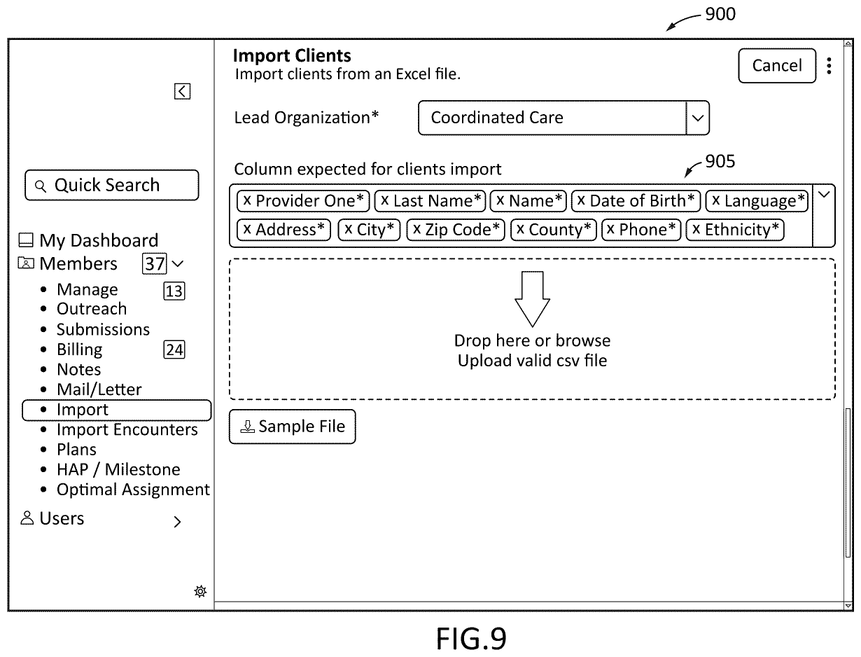

It should be understood that the memory device(s) 268 may include one or more databases or other data structures/repositories. The memory device(s) 268 also includes computer-executable program code that instructs the processing device(s) 256 to operate the network communication interface (e.g., communication adapter 267) to perform certain communication functions of the system described herein. For example, in one embodiment of the entity server(s) 151, the memory device(s) 268 includes, but is not limited to, an entity server data processing application 288, a large-scale data management engine 253, and an operating system 254. The large-scale data management engine 253 may also include an input data processing engine 153, a data rendering engine 275, and/or the like with instructions to carry out the processing of the entity data. The input data processing engine 153 may process the data received by the system, as discussed in reference to FIGS. 4-14B. For example, the input data processing engine 153 may include instructions for processing the interactions between users and providers in order to generate and/or cause to render the user interfaces shown and/or discussed herein. The large-scale data management engine 253 may have various other components that are capable of processing user inputs via a computing device(s) 152. The large-scale data management engine 253 may also include instructions for processing spreadsheets with client imports (e.g., as shown in FIG. 9) to generate user profiles.

Some embodiments of the entity server(s) 151 include processing device(s) 256 communicably coupled to such components as the memory device(s) 268, the communication adapter 267, the input/output adapter 278, the disk drive adapter 272, and/or the like. The processing device(s) 256, and other processors described herein, generally include circuitry for implementing communication and/or logic functions of the system. For example, the processing device(s) 256 may include a digital signal processor device, a microprocessor device, and various analog to digital converters, digital to analog converters, and/or other support circuits. Control and signal processing functions of the entity server(s) 151 are allocated between these devices according to their respective capabilities. The processing device(s) 256 thus may also include the functionality to encode and interleave messages and data prior to modulation and transmission. The processing device(s) 256 can additionally include an internal data modem. Further, the processing device(s) 256 may include functionality to operate one or more software programs, which may be stored in the memory device(s) 268. For example, the processing device(s) 256 may be capable of operating a connectivity program to communicate via the communication adapter 267.

The processing device(s) 256 is configured to connect to the network 100 via the communication adapter 267 to communicate with one or more other devices on the network 100. In this regard, the communication adapter 267 may include various components, such as an antenna operatively coupled to a transmitter and a receiver (together a “transceiver”). The processing device(s) 256 is configured to provide signals to and receive signals from the transmitter and receiver, respectively. The signals may include signaling information in accordance with the air interface standard of the applicable cellular system of the network 100. In this regard, the entity server(s) 151 may be configured to operate with one or more air interface standards, communication protocols, modulation types, and access types. By way of illustration, the entity server(s) 151 may be configured to operate in accordance with any of a number of first, second, third, fourth, and/or fifth-generation communication protocols and/or the like. In various embodiments, the entity server(s) 151 may also be connected via other connection methods to one or more components of the entity system 175.

The I/O adapter 278, which allow the entity server(s) 151 to receive data from a user such as a system administrator, may include any of a number of devices allowing the entity server(s) 151 to receive data from the user, such as a keypad, keyboard 281, touch-screen, touchpad, microphone, mouse, joystick, other pointer device, button, soft key, and/or other input device(s). The user interface may also include a camera, such as a digital camera.

The disk drive adapter 272 may provide additional storage space via disk storage 270. Various other storage mediums may also be used by the entity server(s) 151, such as cloud storage (e.g., transmitted via the communication adapter 267).

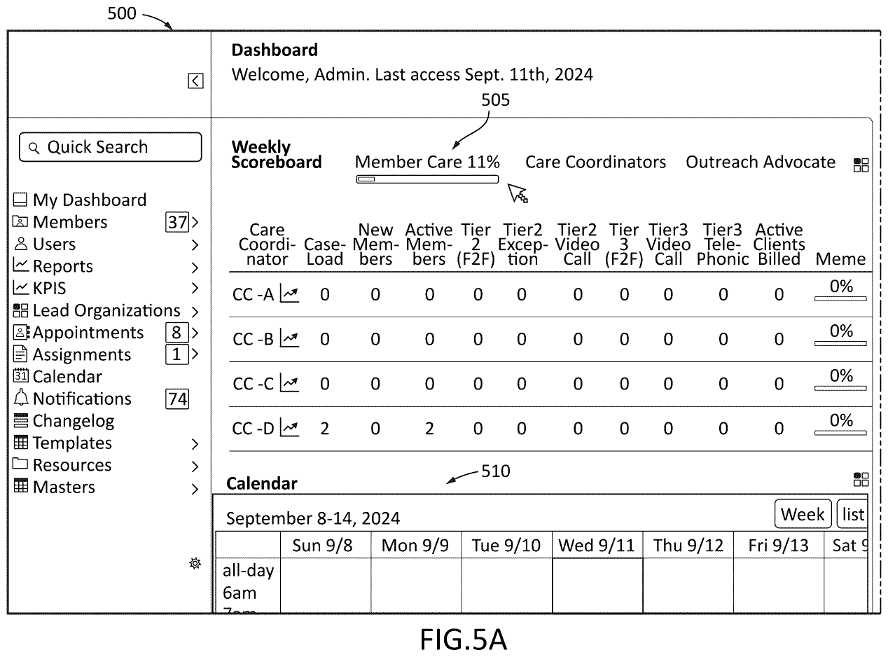

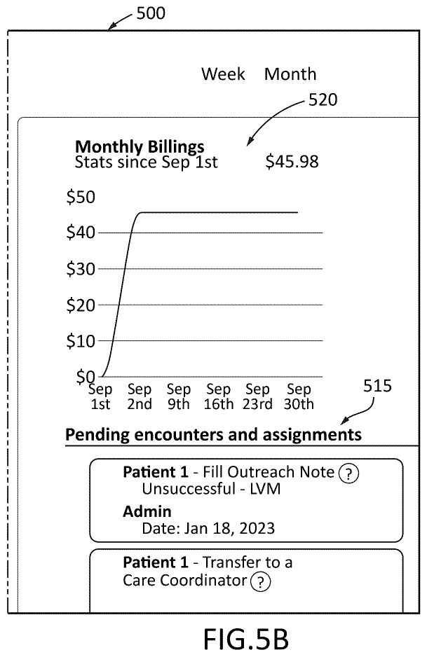

Referring now to FIG. 3, a block diagram illustrating the computing device(s) 152 of FIG. 1, in accordance with various embodiments is provided. FIG. 3 is merely illustrative of an example computing device(s) 152. Various types of computing device(s) 152 may be used or otherwise contemplated for the system. The computing device(s) 152 may be any computing device that is used to process the entity data as discussed herein (e.g., the flowchart 400 of FIG. 4) and/or view the processed data (e.g., as shown in FIGS. 5A-14B).

Example computing devices include desktop computers 107, mobile devices, such as mobile phones 112, tablets, smart watches, etc., laptops 126, and/or the like. As such, the computing device(s) 152 may be any device that is capable of performing the operations discussed herein. For example, a mobile phone may include communication interfaces to communication with mobile networks and local area networks (e.g., via Wi-Fi).

The computing device(s) 152 of FIG. 3 includes one or more processing devices 356, one or more memory devices 368, a display device 380, a communication adapter 367, an input/output adapter 378, and a disk drive adapter 372. In various embodiments, the various components may be connected to one another via a BUS adapter 358 (e.g., the processing device(s) 356 may be attached via a front side BUS 362, the memory device(s) 368 may be attached via a memory BUS 366, the display device 380 may be attached via a video BUS 364, and the communication adapter 367, I/O adapter 378, disk drive adapter 372, and/or other interfaces may be attached via expansion BUS 360).

It should be understood that the memory device(s) 368 may include one or more databases or other data structures/repositories. The memory device(s) 368 also includes computer-executable program code that instructs the processing device(s) 356 to operate the network communication interface (e.g., communication adapter 367) to perform certain communication functions of the system described herein. The memory device(s) 368 may include a large-scale data management engine 388 with instructions on receiving data and/or processing data as discussed herein. The memory device(s) 368 also includes a data rendering engine 350 that includes instructions on generating renderings of user interfaces and/or instructions for rendering such renderings as discussed herein. The memory device(s) 368 may also include the operating system 354 of the computing device(s) 152, which may determine the folder and/or file formatting.

Some embodiments of the computing device(s) 152 include processing device(s) 356 communicably coupled to such components as the memory device(s) 368, the communication adapter 367, the input/output adapter 378, the disk drive adapter 372, and/or the like. The processing device(s) 356, and other processors described herein, generally include circuitry for implementing communication and/or logic functions of the system. For example, the processing device(s) 356 may include a digital signal processor device, a microprocessor device, and various analog to digital converters, digital to analog converters, and/or other support circuits. Control and signal processing functions of the computing device(s) 152 are allocated between these devices according to their respective capabilities. The processing device(s) 356 thus may also include the functionality to encode and interleave messages and data prior to modulation and transmission. The processing device(s) 356 can additionally include an internal data modem. Further, the processing device(s) 356 may include functionality to operate one or more software programs, which may be stored in the memory device(s) 368. For example, the processing device(s) 356 may be capable of operating a connectivity program to communicate via the communication adapter 367.

The processing device(s) 356 is configured to connect to the network 100 via the communication adapter 367 to communicate with one or more other devices on the network 100. In this regard, the communication adapter 367 may include various components, such as an antenna operatively coupled to a transmitter and a receiver (together a “transceiver”). The processing device(s) 356 is configured to provide signals to and receive signals from the transmitter and receiver, respectively. The signals may include signaling information in accordance with the air interface standard of the applicable cellular system of the network 100. In this regard, the computing device(s) 152 may be configured to operate with one or more air interface standards, communication protocols, modulation types, and access types. By way of illustration, the computing device(s) 152 may be configured to operate in accordance with any of a number of first, second, third, fourth, and/or fifth-generation communication protocols and/or the like).

The I/O adapter 378, which allow the computing device(s) 152 to receive data from a user such as a system administrator, may include any of a number of devices allowing the computing device(s) 152 to receive data from the user, such as a keypad, keyboard 381, touch-screen, touchpad, microphone, mouse, joystick, other pointer device, button, soft key, and/or other input device(s). The user interface may also include a camera, such as a digital camera.

The disk drive adapter 372 may provide additional storage space via disk storage 370. Various other storage mediums may also be used by the computing device(s) 152, such as cloud storage (e.g., transmitted via the communication adapter 367).

As described above, the computing device(s) 152 has a user interface that is, like other user interfaces described herein, rendered via the display device 380. The display device 380 include a display (e.g., a liquid crystal display or the like) and/or a speaker or other audio device, which are operatively coupled to the processing device(s) 356. As such, the folder(s) and/or file(s) discussed herein may be provided to the computing device(s) 152 via the display device 380 (e.g., visually via the user interface). in various embodiments, the display device 380 may be in communication with a sound card 374 (e.g., attached to a microphone 376 and/or a speaker 377 (e.g., the speaker 377 may be part of the display device 380 or standalone)).

Referring now to FIG. 4, a flowchart 400 is provided for processing and rendering large-scale data from disparate sources in accordance with various embodiments. In various embodiments, the method of FIG. 4 may be carried out using processing device(s), such as a processing device within one or more computing device(s) 152. As such, the operations herein may be carried out by any of the embodiments herein unless otherwise stated. Unless otherwise stated, the operations of FIG. 4 may be carried out by the same system, such as the systems of various embodiments discussed herein.

Referring now to Block 410 of FIG. 4, the method includes receiving a user profile associated with a user. The user profile may be associated with a user that is a patient or potential patient that has requested services and/or been referred for services by the entity. For example, a user profile may be associated with a potential patient that was referred by a doctor. Additionally or alternatively, the user may be selected based on other targeted interactions (e.g., users may be selected based on user characteristics, location, and/or the like). In various embodiments, the user profile may be generated based on information provided by the user and/or third party entities.

The user profile may include a user type and a geolocation relating to the user. The user type may include information relating to services to be provided to the user. For example, the user type may indicate that a patient needs physical therapy. The user type may also include other characteristics relating to the user that may assist in providing services, such as language spoken, preferred time periods for appointments, preferred credentials for a provider, insurance type, and/or the like.

The geolocation relating to the user is based on an expected location of the user at a given time. The geolocation relating to the user may be static or dynamic. For example, in an instance in which the geolocation is static, the geolocation may indicate a residence or other location in which a patient would be receiving services (e.g., the geolocation may be the location in which a user is going to receive services). Additionally or alternatively, the geolocation relating to the user may be dynamic. For example, the geolocation relating to the user may be based on a GPS location provided by a computing device associated with the user (e.g., a mobile phone). In various embodiments, the geolocation relating to the user may be provided by the user or a third party entities (e.g., vendor, referring provider, and/or other third party agency). For example, a doctor may refer a user using the platform discussed herein and provide contact information for the user.

Referring now to Block 420 of FIG. 4, the method includes determining one or more potential providers from one or more providers for the user based on the user profile. In various embodiments, the environment discussed herein may have one or more providers. Each provider may be part of the entity and/or contracted through the entity. As such, the provider(s) are known people and/or third-party entities that are capable of providing services. For example, in an instance in which the environment herein is used for a healthcare application, the provider(s) may provide services related to healthcare, such as physical therapy, occupational therapy, and/or other medical services. As such, the one or more potential providers are selected from the one or more known providers. The potential providers may be a subset of providers that fit a criteria relating to the user profile.

In various embodiments, the potential provider(s) may be selected based on location. Each provider may have a known provider location. The known provider location may be an expected location of the provider (e.g., typical starting point for the provider, office for the provider, etc.) and/or an actual location of the provider (e.g., real-time or near real-time GPS information, provider provided information, location of previous appointment, etc.). As such, the known provider location indicates the location of the provider. The potential provider(s) may be determined based on the known provider location for each provider. The known provider location may be based on a route or other expected travel plan for the provider. For example, the provider may have a planned route and/or a planned route may be generated based on known tasks for the provider. The known provider location may be an expected location for the provider based on other tasks.

In various embodiments, the potential provider(s) may be selected based on a distance between the given known provider location and the geolocation relating to the user. For example, the potential provider(s) may be any provider that is within a given range of the geolocation relating to the user.

In various embodiments, the comparison of the known provider location and the geolocation relating to the user may be based on travel time and/or travel distance. For example, the potential provider(s) may be any provider within a given range of miles from the geolocation relating to the user and/or the potential provider(s) may be any provider within a given range of travel time from the geolocation relating to the user. Additionally, the distance between the known provider location and the geolocation relating to the user may use travel distance (e.g., the distance required to travel from the known provider location and the geolocation relating to the user). For example, a provider may be physically close to a user located opposite a mountain, but would have to travel around the mountain to get to the user.

In various embodiments, the potential provider(s) may be filtered (e.g., removed) based on factors other than known provider location. For example, potential provider(s) may be filtered based on availability (e.g., scheduled appointments, time off, etc.). The availability may be based on a schedule or calendar for the provider (e.g., the system may connect to a calendar application and/or provide a native calendar application for the provider to input availability). The availability may be based on typical hours (e.g., a provider may have a standard operating hours and days of the week).

The availability of the provider may be compared to the availability of the user (e.g., desired time, general availability, etc.). For example, in an instance in which a user requested an appointment for Monday and any provider that is not available on Monday would be removed from the potential provider(s). The availability of the user may be based on information provided by the user (e.g., a patient may indicate that an appointment is requested during weekdays) and/or based on expected availability (e.g., a user may be considered to be available during normal operating hours unless otherwise noted). In some instances, the user type (e.g., services needed by the user) may indicate the availability of the user. For example, in an instance in which a user needs urgent services (e.g., physical therapy after a surgery may be required to begin as soon as a patient returns home from the surgery), the availability for the user may be listed for a short time period (e.g., the availability of the user may be limited to the next day). In such an example, any potential providers that were not available within the time range would be removed from the potential provider(s).

The removal of a provider from the potential provider may be done after the potential provider(s) are selected or before the potential provider(s) are selected. For example, providers that are unavailable may be removed from consideration to be selected as a potential provider or the potential provider(s) may be analyzed after selection to determine any providers that are unavailable. As such, removing and/or filtering of the potential provider(s) may be completed before or after the determination of the potential provider(s).

Referring now to optional Block 430 of FIG. 4, the method includes removing one or more potential providers based on the user type of the user profile. As discussed above in reference to Block 430 of FIG. 4, potential provider(s) may be filtered based on various factors. In various embodiments, the user type (e.g., services needed) may affect the potential provider(s). For example, a provider may be physically close to the user, but not provide the type of services requested and/or needed by the user. As such, the system may determine the potential providers that are capable of rendering services to the user based on the user type. The potential providers may also be ranked or otherwise compared based on the user type (e.g., some providers may be better suited for a specific type of service than another provider that also provides the service).

The removal of the potential providers may be based on a provider profile associated with each of the one or more potential providers. The provider profile may indicate information relating to provider, such as services offered, specialties, languages spoken, general availability, current workload, and/or the like. The system may compare the provider profile of the potential provider(s) to the needs of the user to determine which provider suits the request the best. The comparison may be used to determine a primary provider, as discussed in reference to Block 440 of FIG. 4.

Referring now to optional Block 440 of FIG. 4, the method includes determining a primary provider of the one or more potential providers. The determination of the primary provider may be based on the distance (e.g., physical distance, travel distance, travel time, etc.) between the known provider location of each of the one or more potential providers and the geolocation associated with the user. For example, a primary provider may be the potential provider that is the closest to the user. Additionally or alternatively, the primary provider may be selected using other factors than distance from the user. For example, the primary provider may be determined based on the user type (e.g., services needed), the provider profile (e.g., services offered, specialties, languages spoken, general availability, current workload, etc.), user request (e.g., a user may indicate one or more preferred providers), provider rating (e.g., ratings provided by the user and/or other users), experience level of the provider (e.g., providers with more experience and/or more time on the system may be preferred for selection), and/or the like.

The determination of the primary provider may be automated (e.g., based on the various factors discussed herein) and/or based on a received input (e.g., an entity user may select the primary provider from the potential provider(s) or the user may select the primary provider from the potential provider(s)). The system may assign a primary provider or recommended primary provider that can either be confirmed or modified by an entity user and/or a user. The selection may be assigned by rendering optimal assignments (e.g., recommended provider based on location and/or other factors).

Upon determination of the primary provider for a user, the primary provider may be assigned to or otherwise associated with the user profile associated with the user (e.g., the primary provider and the user profile may be linked). The primary provider may be assigned one or more tasks upon assignment of the user (e.g., initial contact, appointments, etc.). For example, the system may provide the primary provider with the tasks via a user interface. In various embodiments, the provider may have tasks for different users assigned to the provider.

The primary provider may be preferred in future scheduling of appointments for a user. For example, the primary provider may be the default choice for scheduling an appointment in an instance both the user and the primary provider has availability. In various embodiments, future appointments may be scheduled based on the availability of the primary provider and/or known provider location of the primary provider. For example, a recurring appointment may be made at a set interval (e.g., every two weeks) and allow a buffer time period to allow for the appointment to be with the primary provider. For example, a user may have a need for an appointment every two weeks (e.g., for physical therapy) and the buffer time period may be two days to allow for the day and time to be selected in which the primary provider is available and nearby the user.

In various embodiments, the primary provider may be the only provider scheduled for a user. Alternatively, the primary provider may be preferred, but a user may be able to schedule an appointment with another provider (e.g., the system may notify the user that the primary provider is not available during the next appointment window and the user may request a different provider).

Referring now to Block 450 of FIG. 4, the method includes causing a rendering of the one or more potential providers for selection to be associated with the user. Example renderings of a portal are shown in FIGS. 5A-14B. The portal may also be used to display the potential provider(s). The rendering of the one or more potential providers may include a distance between the known provider location for each of the one or more potential providers and the geolocation relating to the user. For example, the rendering may include each potential provider with a distance from the user (e.g., either visually via a map or textually). The rendering of the potential provider(s) may be used to determine the primary provider (e.g., the entity user or the user may select the primary provider via an input in response to the rendering).

In an instance in which only one potential provider is determined, the selection of the provider may be in the form of a confirmation that the single potential provider is adequate. In various embodiments, the user may be able to adjust search filters to remove and/or add potential providers to the potential provider(s). The system may filter out one or more providers for one or more factors and the user may indicate that the factor is not an issue. For example, a user may have a preferred spoken language that is considered to select the potential provider(s), but is capable of speaking other languages and may deselect the search filter. In various embodiments, the determination of one or more potential providers may be updated and/or reran in response to the user input. In another example, the user may input an updated availability (e.g., a user may request a first availability, but may have other availabilities). As such, the determination of one or more potential providers may be updated and/or reran in response to the updated availability.

Referring now to optional Block 460 of FIG. 4, the method includes providing route information between the known provider location of at least one of the one or more potential providers and the geolocation of the user. The route information may be provided during the selection of the provider (e.g., a route may be rendered for one or more potential providers for an entity user or user to select the primary provider). Alternatively, the route information may be provided to the provider during the contact.

The route information may have route information for one task for a provider. Alternatively, the route information may have route information for multiple tasks over a period of time. For example, a provider may receive route information for each task for a day to allow the provider to visualize and/or otherwise plan the day.

The route information may be provided to the provider visually (e.g., via words and/or mapping) and/or audibly (e.g., mapping instructions). In various embodiments, the system may have an embedded mapping system and/or be connectable to third party mapping systems that allow the route information to be provided to the user. The route information may be static (e.g., provide an image of the map for a route) and/or dynamic (e.g., provide real-time or near real-time updates to the route). The route information may include traffic and/or other factors that may affect the route. In various embodiments, the route information may be updated in real-time or near real-time based on traffic and/or other factors that affect the route.

In various embodiments, provider tasks may be updated based on traffic and/or other factors that change the location of the provider. For example, during the course of a day, a user may experience user cancellations, traffic, unexpected time periods for tasks (e.g., either shorter than expected or longer than expected), and/or the like that may change the capabilities of the provider. In various embodiments, the provider schedule may be updated based on such factors. For example, a provider that has been delayed may have one or more tasks changed (e.g., delayed, moved to another day, cancelled, moved to another provider, etc.). As such, the system may determine potential providers in real-time or near real-time to allow such an update to occur. For example, a provider may be delayed, and the task may be shifted to another provider that is closer and has availability. The user may have user settings that determine whether providers are updated near the time of a task (e.g., some users may prefer having a task at a certain time regardless of provider, some users may be okay with changing a provider up until a certain time before a task, some users may only want a specific provider, etc.). As such, the system may determine whether a route should be updated for a provider based on the various factors.

FIGS. 5A-14B illustrate various example user interfaces that may be provided to various computing device(s) associated with the system. The system may include a portal that renders various user interfaces based on the processed data herein. The user interfaces of FIGS. 5A-14B are merely an example and illustrate information that can be rendered. The visual presentation of the data, as well as the accessibility of the data may be based on the permissions for an account (e.g., administrators, supervisors, providers, users, and/or the like may each be able to access different portion of the data generated by the system). For example, a provider may only be able to access data associated with a user profile that is relevant for rendering services to the user.

FIGS. 5A and 5B illustrate an admin dashboard 500 (FIG. 5A and FIG. 5B may be viewed as a single dashboard combined along the dotted lines). The admin dashboard 500 may be provided to an administrator or other entity user (e.g., via a user interface) that allows the administrator to monitor providers (e.g., care coordinators). In various embodiments, the portal provided in various embodiments may allow for different permission levels that may affect the information provided via the user interfaces. For example, an administrator may view information relating to multiple providers, while a provider may only have access to information about the provider (e.g., assigned patients, assigned tasks, etc.).

In various embodiments, the system may generate a scoreboard (e.g., weekly scoreboard 505) that displays statistics relating to providers (e.g., care coordinators) and/or outreach advocates. The scoreboard may include statistics, such as number of user interactions, interested clients, engagement rate (e.g., percentage of assigned users to contact), and/or the like. The scoreboard may allow an entity user to compare different providers and/or outreach advocates. The scoreboard may be rendered only to specific entity users (e.g., a supervisor or administrator).

In various embodiments, the admin dashboard 500 may include various sections, such as a calendar section 510 (e.g., displaying the admin schedule and/or other people within the system), an encounter/assignment section 515 (e.g., detailing tasks for the entity user, providers, outreach advocates, and/or the like), a billing section 520 (e.g., displaying billings over time). The different sections may include numerical, textual, graphical, and/or the like to display information. The system may use the information inputted (e.g., input by the providers, outreach advocates, entity users, user, and/or the like) to generate the different sections.

In various embodiments, a member care percentage may be provided that indicates the performance of the providers. For example, in an instance in which 100 users have been assigned to provider(s), the member care percentage may indicate the amount of the 100 users that have been contacted and/or billed for a contact. A lower member care percentage may indicate that providers are underperforming and/or other issues are occurring (e.g., too many users assigned to each provider).

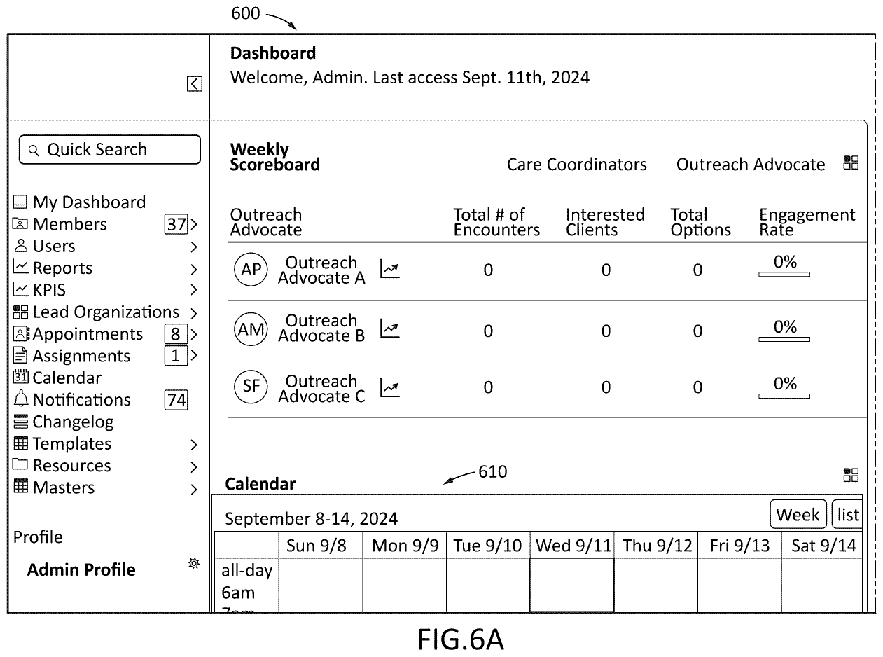

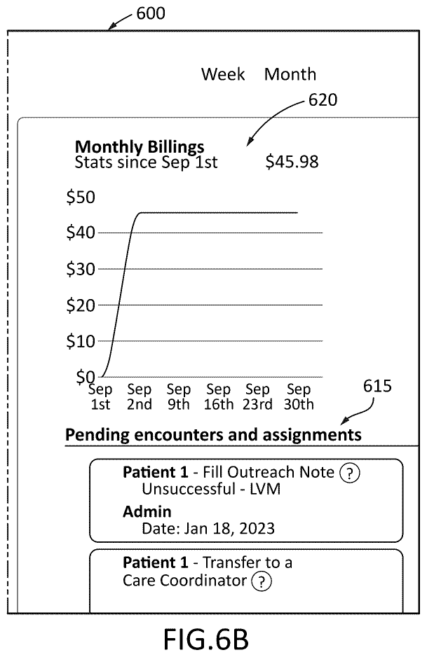

FIGS. 6A and 6B illustrate the admin dashboard 500 displaying information relating to outreach advocates (FIG. 6A and FIG. 6B may be viewed as a single dashboard combined along the dotted lines). An outreach advocate may coordinate with users (e.g., patients) during an intake process. For example, an outreach advocate may contact users that are referred, request services, and/or otherwise targeted for services. Admin dashboard 50 illustrates a weekly scoreboard 600 that is associated with outreach advocates. Any number of different scoreboards may be generated for different types of accounts (e.g., care coordinators, outreach advocates, etc.).

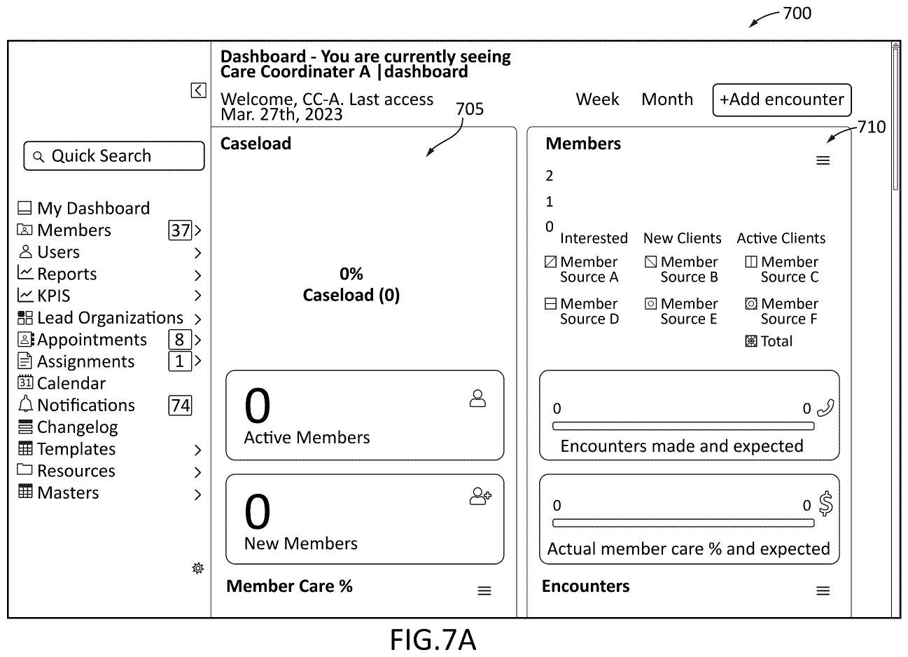

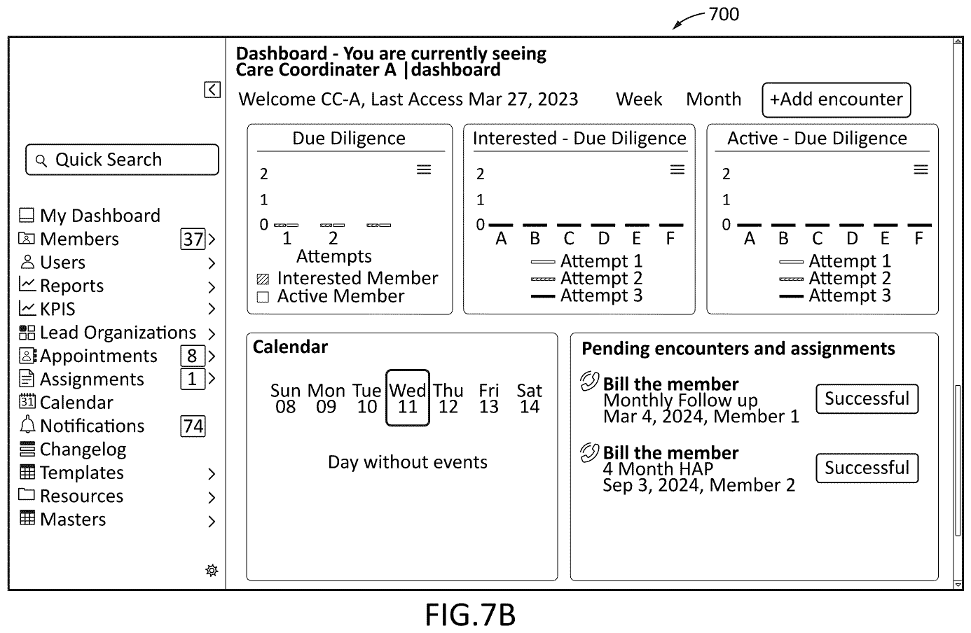

FIGS. 7A and 7B illustrate a provider dashboard 700. The provider dashboard 700 may be provided to a provider (e.g., a care coordinator) that allows the provider to view information relating to the provider (e.g., statistics, assigned tasks, assigned users, etc.). The provider dashboard 700 and portal may be used by a provider to receive assignments, receive tasks, complete records relating to interactions with users, and/or the like.

The provider dashboard 700 may include various sections that provide information relating to caseload 705 (e.g., the number of patients compared to a maximum amount), member stats 710 (e.g., across different sources of member assignments), and/or the like. The provider dashboard 700 is generated using information inputted (e.g., input by the providers, outreach advocates, entity users, user, and/or the like).

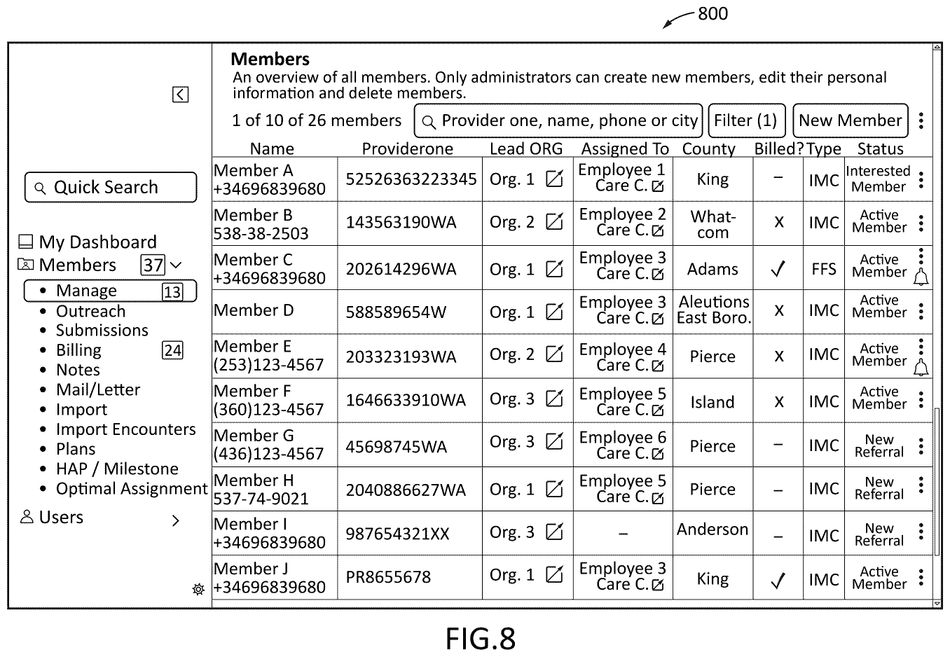

FIG. 8 illustrates a member list page 800 in accordance with various embodiments. The member list page 800 may include any users (e.g., patients). The member list page 800 may include the name of a user, the contact information of the user, the assigned provider (e.g., primary provider), the status of the user (e.g., new patient, existing patient, etc.), and/or the like. The member list page 800 may include information that is stored on the user profile associated with the user. Additionally, the member list page 800 may include information relating to whether the user has been billed. The users listed on the member list page 800 may be based on the type of account. For example, a provider may only have users assigned to the provider listed on the member list, while an administrator may have access to more or all of the users on the member list page 800.

FIG. 9 illustrates a client import page 900 in accordance with various embodiments. The client import page 900 allows clients to be input. The client input may be manual (e.g., an entity user may input each client information) and/or automated (e.g., client(s) may be imported from documents, such as a spreadsheet).

The automated client input may be completed by coordinating the columns in a spreadsheet to expected fields in the system. For example, the columns expected for client import 905 may be adjusted by an entity user (e.g., the entity user may select the columns in order (e.g., column 1 is “Provider one”, column 2 is “Last Name”, column 3 is “Name”, column 4 is “Date of birth”, column 5 is “Language”, column 6 is “Address”, column 7 is “City”, column 8 is “Zip code”, column 9 is “County”, column 10 is “Phone”, column 11 is “Ethnicity”). The columns expected for client import 905 may be adjusted based on different spreadsheets (e.g., the different fields may be dragged and dropped in different orders based on the spreadsheet format).

Based on the columns expected for client import 905, the system may parse the spreadsheet and import any users listed in the spreadsheet. The users imported may be cross-referenced with existing users to remove any duplicative users (e.g., the users in the spreadsheet may be compared to the user profile information, such as name, contact information, geolocation relating to the user). The information in the spreadsheet may be used to create user profiles relating to the users. The user profile may include the information in the spreadsheet (e.g., name, date of birth, language, geolocation, etc.). Upon generation of the user profile, the user may be assigned to a provider (e.g., as discussed in reference to FIG. 4 above) and tasks may be generated relating to the user (e.g., initial contact, user type based appointments, etc.).

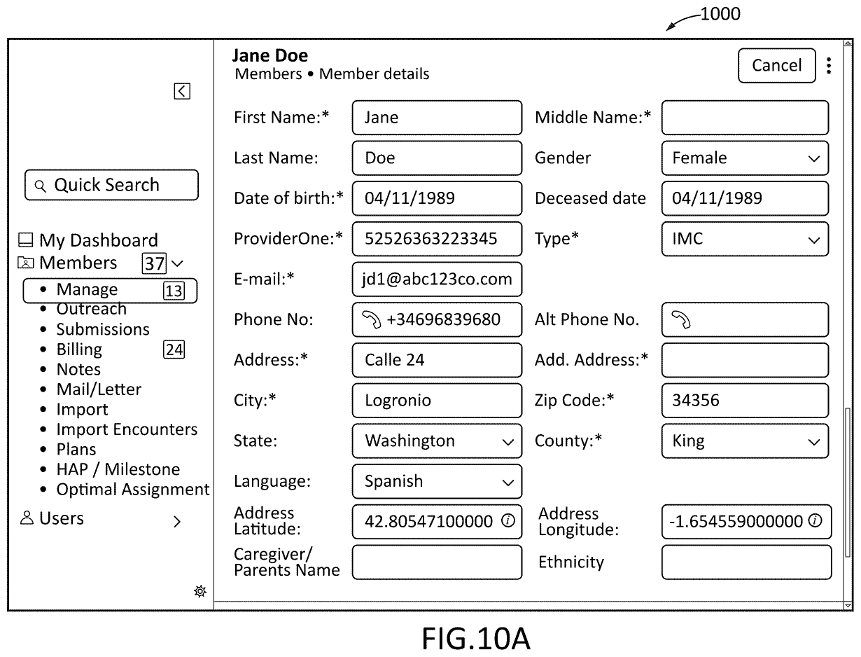

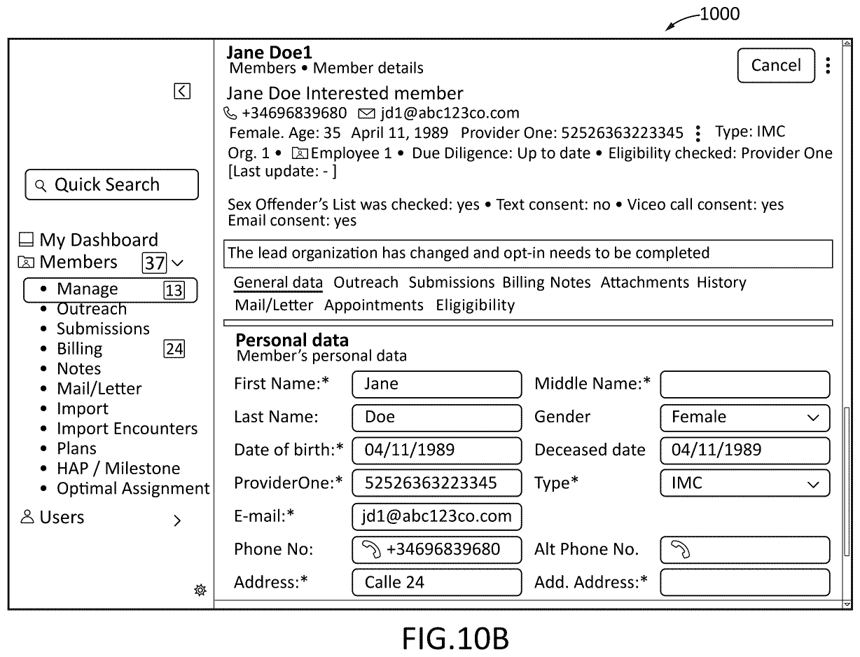

FIGS. 10A and 10B illustrate a user profile page 1000 in accordance with various embodiments. The user profile page 1000 includes information relating to a user. In various embodiments, the user profile for a user may include name, contact information, personal information, geolocation relating to the user, user type (e.g., type of services needed), and/or the like. At least one entry in the user profile may be obtained from the client import shown in FIG. 9. The user profile may be modified (e.g., an administrator or provider may have permission to modify the user profile (e.g., add information, correct information, etc.).

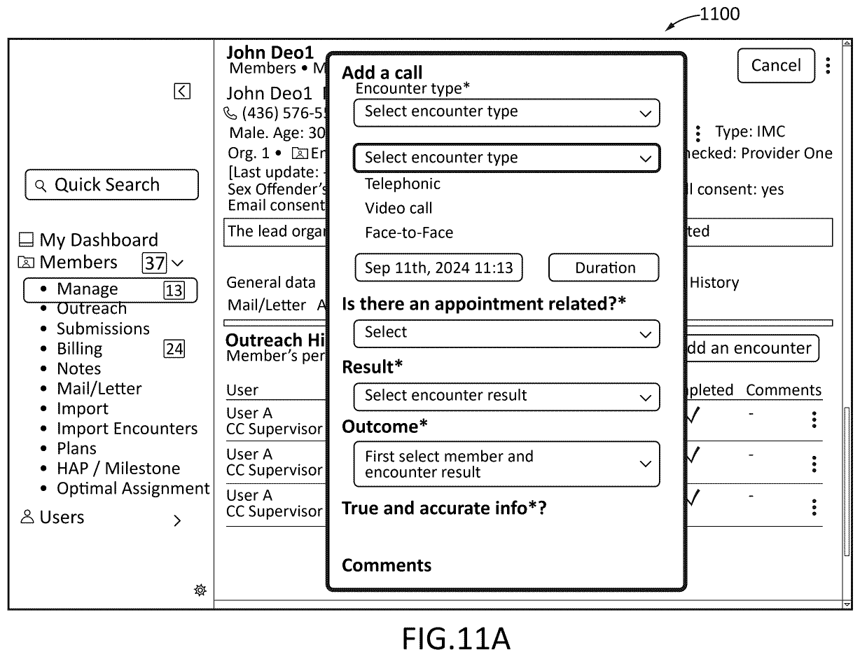

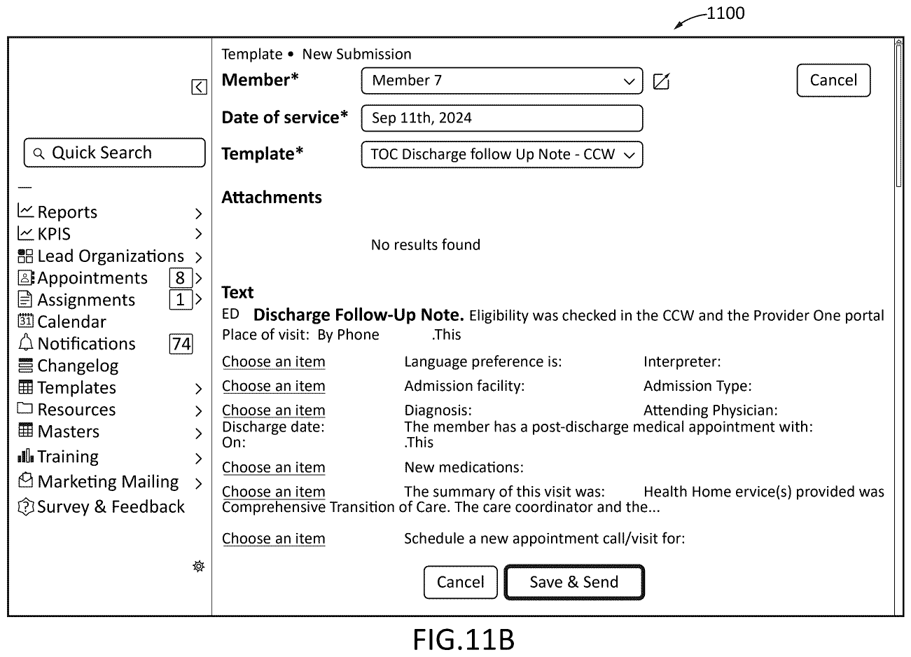

FIGS. 11A and 11B illustrate a user interface 1100 that is rendered for recording interactions with a user. As shown, the system may allow an interaction to be recorded (e.g., a provider may record the results of an interaction with the user). An interaction may include any contact between the provider and user (e.g., phone calls, video calls, messages, in-personal contacts, etc.). As shown in FIG. 11A, the provider may enter the type of interaction or encounter with the user (e.g., telephonic, video call, face-to-face, etc.). Based on the selected interaction type, the options for recording the interaction are updated.

Based on the inputs relating to the interaction, a recommended interaction summary 1105 may be provided, as shown in FIG. 11B. The recommended interaction summary 1105 may be formatted based on a system template. The system template may be compliant with one or more requirements (e.g., legal requirements, third party reporting requirements, etc.). For example, the recommended interaction summary 1105 may be formatted in compliance with an insurance company requested format to ensure that the interaction is properly detailed for insurance purposes.

The record from the interactions with a user may be used for future scheduling for a user. For example, the provider may indicate that the user needs another provider for the next appointment. As such, the provider may be removed from the pool of potential providers for future scheduling. The record from the interactions may also be used to update the user profile (e.g., a provider may indicate that a user has a preferred spoken language or other factor that may affect the selection of potential providers. As such, user profiles may be updated based on the record from the interactions. In various embodiments, the record from the interactions may also be saved in raw form in the user profile (e.g., a user or a provider may be able to access a record from previous interactions within user profile). As such, the provider may access records from previous interactions to provide customized service to the user.

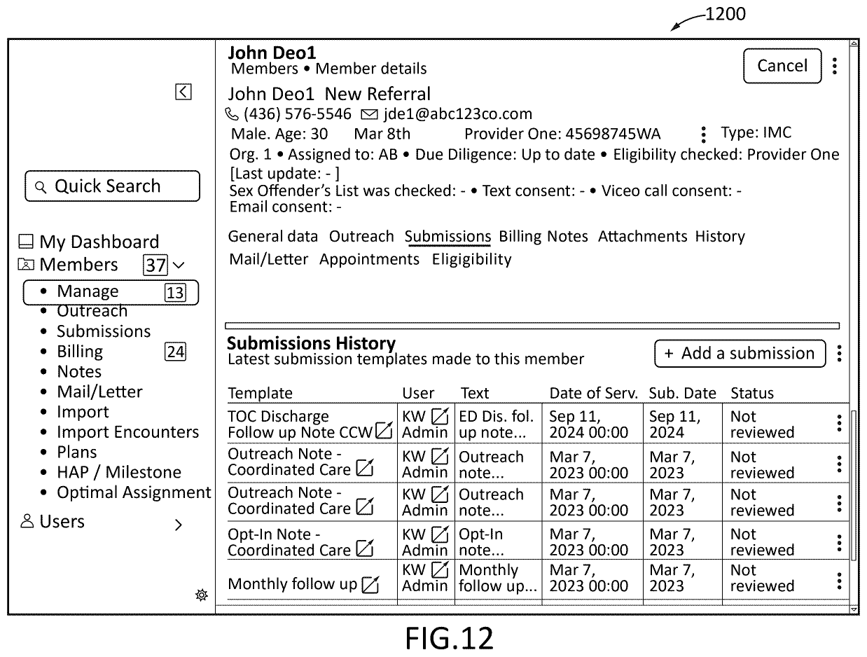

FIG. 12 illustrates another example user profile page 1200. The user profile page 1200 includes information relating to previous interactions with the user. For example, the submission history 1205 includes notes that relate to each interaction with the user. The submission history 1205 may include the type of interaction (e.g., the template used based on the interaction), the interacting party (e.g., provider, administrator, etc.), date of service and/or submission, status of verification, and/or the like.

The user profile may be accessible by the user and/or other users authorized by the user (e.g., a user may allow for the user profile to be viewed by a family member). The user profile may also be accessible by a provider (e.g., a provider that is assigned a task with the user may be able to access the user profile for the user). In various embodiments, the user may be able to select a portion of the user profile that is accessible by a provider (e.g., a user may not want a provider to have access to certain portions of a user profile). In various embodiments, a provider may have limited access to the user profile based on the task assigned to the provider. For example, only interactions relating to the task may be shown on the user profile (e.g., certain provider interactions may not be relevant to a provider).

The system may have safeguards to allow for the user profile to be viewed by a provider without violating any laws, such as HIPAA laws. For example, the type of provider may determine the information that is viewable to the provider within a user profile. Moreover, certain portions of the user profile may ever be accessible by a provider. In various embodiments, the system may determine the information within a user profile that may be displayed to a provider and adjust the rendering of the user profile (e.g., certain portions may be restricted or otherwise removed from the user profile in an instance in which the provider views the user profile).

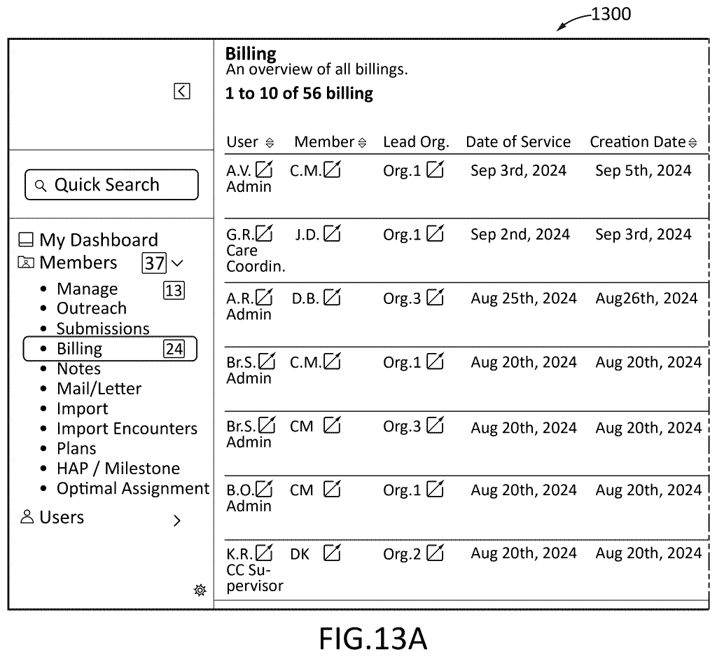

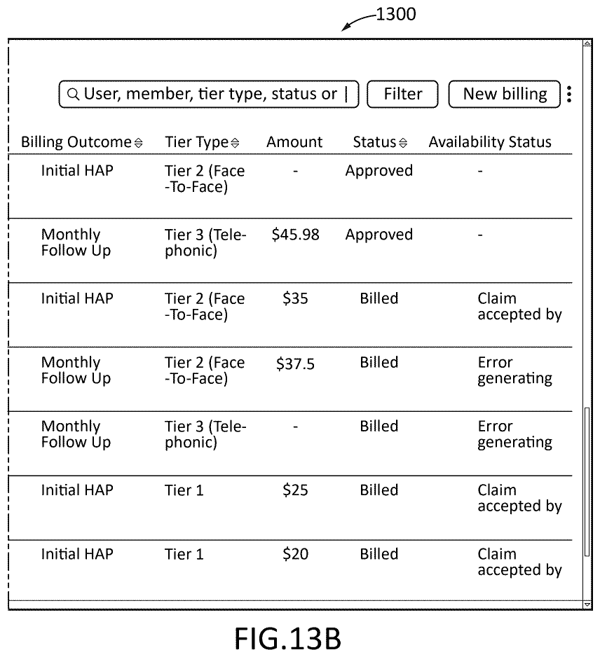

FIGS. 13A and 13B illustrate an example billing page 1300 (FIG. 13A and FIG. 13B may be viewed as a single page combined along the dotted lines). The system allows for the billing process to be streamlined based on the recorded interactions between providers and users. In various embodiments, a billing may be generated based on a recorded interaction that includes billable services. For example, a recorded interaction may indicate that an at-home visit was conducted and a billing may be generated for the at-home visit.

In various embodiments, the billing may also indicate an instance in which a billing event (e.g., an appointment) may have occurred and whether any billing (e.g., an invoice) was generated. For example, a provider may be responsible for generating an invoice and the system may indicate that an interaction occurred, but no invoice was generated. The system may also include billing information relating to the method of notification and/or payment (e.g., autopay, mailed billing, email billing, insurance payment, etc.).

Since billing is incorporated into the system, the system may also use billing information to select providers for a user, such as selecting providers based on accepted insurance, standard rates, and/or the like. For example, certain providers may be more or less costly to a user based on factors, such as user insurance, user location, and/or the like. As such, the potential provider(s) selected may be selected at least in part based on expected cost for a user (e.g., a user may receive a cost estimate and/or the potential providers may be rendered sorted by a cost estimate). In various embodiments, the integration may allow the cost to be transparent for a user, such that the cost may be known at the time at which a provider is assigned to a user for a task.

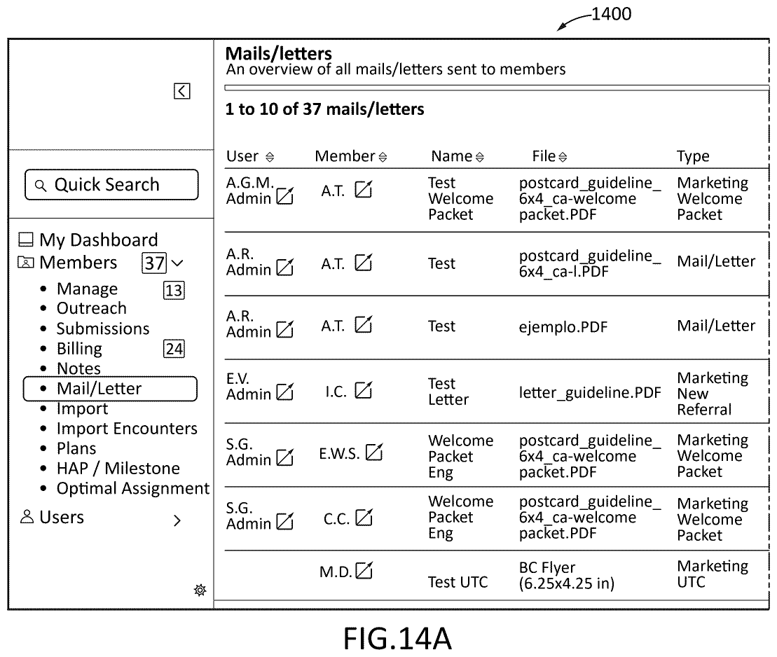

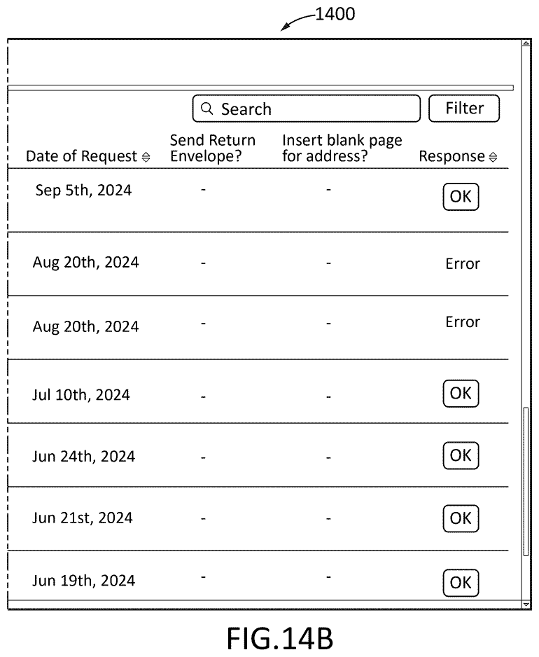

FIGS. 14A and 14B illustrates an example contact page 1400 (FIG. 14A and FIG. 14B may be viewed as a single page combined along the dotted lines). The contact page 1400 includes details relating to contacts (e.g., mailings, letters, etc.). The contacts may be automated. The automation may be based on the user profile relating to a given user. The contacts may include mailings, electronic contacts (e.g., email, social media contact, etc.), phone calls, and/or the like. The contacts may be standard for different criteria of users (e.g., a new patient may receive an initial contact with new patient information, a user that misses a scheduled interaction may receive a contact with instructions for rescheduling, a user that receives certain services may receive contacts with tips for improving the services, a user in a certain area may receive area specific contacts, and/or the like.

The system may determine contacts based on the user profile (e.g., user information, such as name, language, geolocation, user type, etc.), past interactions (e.g., a provider may indicate that a user has requested assistance and the contact may provide assistance or contact information for assistance), changes to providers (e.g., a contact may be generated in an instance in which a new primary provider is assigned to a user), and/or the like. The contact type (e.g., email, phone call, mailing, etc.) may be based on the nature of the contact (e.g., a time sensitive contact may be a phone call or email) and/or user preferences (e.g., a user may opt for digital only contacts).

Due to the size of user bases, systems have a hard time processing the user information in order to provide effective and timely contacts. As the user base increases, it becomes impossible for entities to manually communicate without any lag. The operations herein allow data to be received from different sources located remote from one another (e.g., different providers are located throughout a service area and the patients are also located in different locations). The data received from disparate sources is then processed in real-time or near-real time to create provider assignments, tasks associated with the patient, route information, and/or the like. As the amount of providers and patients increase, manual operations become impossible. To combat the difficulties, entities are traditionally smaller in size and service area, creating strain on network resources caused by having multiple different entities using redundant resources. The system of the present disclosure allows for improved communication without requiring unnecessary processing. Moreover, the system allows for scaling that eliminates that allows for a reduction in computing resources necessary to provide services across a larger area (e.g., the system can replace multiple different entities that are each using similar resources).

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method for processing and rendering large-scale data from disparate sources, the method comprising:
receiving a user profile associated with a user, wherein the user profile comprises a user type and a geolocation relating to the user;
determining one or more potential providers from one or more providers for the user based on the user profile, wherein the one or more potential providers is determined based on a known provider location for each of the one or more providers; and
causing a rendering of the one or more potential providers for selection to be associated with the user, wherein the rendering of the one or more potential providers comprises a distance between the known provider location for each of the one or more potential providers and the geolocation relating to the user.

2. The method of claim 1, further comprising determining a primary provider of the one or more potential providers, wherein determining the primary provider is based on the distance between the known provider location of each of the one or more potential providers and the geolocation associated with the user.

3. The method of claim 2, further comprising assigning the primary provider to the user profile, wherein the primary provider is linked to the user profile.

4. The method of claim 2, wherein the primary provider is assigned one or more tasks associated with the user.

5. The method of claim 4, wherein the one or more tasks are rendered via a user interface on a device associated with the primary provider.

6. The method of claim 1, wherein the one or more potential providers are filtered based on an availability for each of the one or more potential providers.

7. The method of claim 6, wherein filtering the one or more potential providers comprises removing any potential provider that is unavailable for a potential contact with the user.

8. The method of claim 1, further comprising removing one or more potential providers based on the user type of the user profile, wherein the removal is based on a provider profile associated with each of the one or more potential providers.

9. The method of claim 1, wherein the user type comprises information relating to services to be provided to the user.

10. The method of claim 1, further comprising providing route information between the known provider location of at least one of the one or more potential providers and the geolocation of the user.

11. A system for processing and rendering large-scale data from disparate sources, the system comprising:
at least one non-transitory storage device; and
at least one processing device coupled to the at least one non-transitory storage device, wherein the at least one processing device is configured to:
receive a user profile associated with a user, wherein the user profile comprises a user type and a geolocation relating to the user;
determine one or more potential providers from one or more providers for the user based on the user profile, wherein the one or more potential providers is determined based on a known provider location for each of the one or more providers; and
cause a rendering of the one or more potential providers for selection to be associated with the user, wherein the rendering of the one or more potential providers comprises a distance between the known provider location for each of the one or more potential providers and the geolocation relating to the user.

12. The system of claim 11, wherein the at least one processing device is further configured to assign a primary provider to the user profile, wherein the primary provider is linked to the user profile.

13. The system of claim 12, wherein the primary provider is assigned one or more tasks associated with the user.

14. The system of claim 13, wherein the one or more tasks are rendered via a user interface on a device associated with the primary provider.

15. The system of claim 11, wherein the at least one processing device is further configured to remove one or more potential providers based on the user type of the user profile, wherein the removal is based on a provider profile associated with each of the one or more potential providers.

16. A computer program product for processing and rendering large-scale data from disparate sources, the computer program product comprising at least one non-transitory computer-readable medium having one or more computer-readable program code portions embodied therein, the one or more computer-readable program code portions comprising at least one executable portion configured to:
receive a user profile associated with a user, wherein the user profile comprises a user type and a geolocation relating to the user;
determine one or more potential providers from one or more providers for the user based on the user profile, wherein the one or more potential providers is determined based on a known provider location for each of the one or more providers; and
cause a rendering of the one or more potential providers for selection to be associated with the user, wherein the rendering of the one or more potential providers comprises a distance between the known provider location for each of the one or more potential providers and the geolocation relating to the user.

17. The computer program product of claim 16, wherein the one or more computer-readable program code portions comprise at least one executable portion further configured to assign a primary provider to the user profile, wherein the primary provider is linked to the user profile.

18. The computer program product of claim 17, wherein the primary provider is assigned one or more tasks associated with the user.

19. The computer program product of claim 18, wherein the one or more tasks are rendered via a user interface on a device associated with the primary provider.

20. The computer program product of claim 16, wherein the one or more computer-readable program code portions comprise at least one executable portion further configured to remove one or more potential providers based on the user type of the user profile, wherein the removal is based on a provider profile associated with each of the one or more potential providers.
